(19) United States
(12) Patent Application Publication
(10) Pub. No.: US 2006/0147742 A1
(43) Pub. Date: Jul. 6, 2006

(54) Composite copper foil, method of production thereof and high frequency transmission circuit using said composite copper foil

(76) Inventors: Akira Matsuda, Tochigi (JP); Yuuji Suzuki, Tochigi (JP); Akitoshi Suzuki, Tochigi (JP)

Correspondence Address: ARENT FOX PLLC, 1050 CONNECTICUT AVENUE, N.W., SUITE 400, WASHINGTON, DC, 20036, US

(21) Appl. No.: 10/543,917

(22) PCT Filed: Feb. 4, 2004
(86) PCT No.: PCT/JP04/01107

§ 371 Date: Jul. 29, 2005

(30) Foreign Application Priority Data
Feb. 4, 2003 (JP) 2003-026626
Feb. 4, 2003 (JP) 2003-026630

(51) Int. Cl. B32B 3/00; C21D 1/70; B21C 37/00; B32B 15/01; B32B 15/20; B23P 9/00

(52) U.S. Cl. 428/607; 428/674; 428/675; 428/673; 428/687; 428/209; 148/537

(57) ABSTRACT

A composite copper foil excellent in conductivity and surface shape, having high strength and able to be used for applications such as high frequency transmission circuits and a method of production of the same are provided. A composite copper foil characterized by having a copper foil on at least one surface of which a copper and/or silver smoothing layer is provided. Further, producing this by processing an ingot having a copper alloy to a foil having a desired thickness by rolling, then forming on at least one surface of the processed copper alloy foil a smoothing layer by copper plating and/or silver plating. Alternatively, producing this by processing an ingot having a copper alloy to a foil having a thickness of an intermediate size by rolling, forming on at least one surface of the foil a smoothing layer by copper plating and/or silver plating, then rolling the result to a foil having a desired thickness or applying heat treatment or applying heat treatment and rolling to thereby make the thickness of at least the copper and/or silver plating layer at the surface of the foil 0.01 μm or more. Further, a high frequency transmission circuit characterized by being prepared using the above composite copper foil or the composite copper foil produced by the above method of production.

### TECHNICAL FIELD

The present invention relates to a composite copper foil excellent in strength, conductivity, and surface shape and a method of production of the composite copper foil and for example provides a composite copper foil optimum for the application of a high frequency transmission circuit such as an antenna of an IC card, a method of production of the same, and a high frequency transmission circuit using the composite copper foil.

### BACKGROUND ART

In recent years, due to the demands for reduction of the size and increase of the processing speed of high performance electronic equipment, the materials used for their circuit interconnects have generally been thin types advantageous for reducing the pitch and lightening the weight and have been required to have a low impedance with respect to a high frequency current. One example of such equipment is an IC card.

Up until recently, mainly magnetic strip cards storing magnetic signals have been widely utilized in various fields such as bank cards, credit cards, telephone cards, and bonus point cards due to their convenience in carrying. As opposed to this, IC cards have built-in ICs inside the cards, so enable more sophisticated judgment and complex processing. They also have storage capacities about 100 times greater than magnetic strip cards, enable reading/writing of information, and are high in safety.

The methods of transmission of information of IC cards include the contact type of communicating by physical contact with contacts and also the non-contact type enabling communication across a spatial distance of as much as a few meters using electromagnetic waves etc.

Due to these features of IC cards, IC cards are expected to be utilized in a very wide range of applications such as ID cards, train and bus ticket, commuter passes, electronic money, highway passes, health insurance cards, resident cards, medical cards, and physical distribution control cards.

Non-contact type IC cards are currently classified into four types according to the communication distance: the touch type (communication distance up to 2 mm), proximity type (same, up to 10 cm), midrange type (same, up to 70 cm), and microwave type (same, up to several meters). The communication frequencies extend from the MHz to the GHz, for example, 4.91 MHz in the touch type, 13.56 MHz in the proximity type and the midrange type, and 2.45 to 5.8 GHz in the microwave type.

A non-contact type IC card basically is constructed from an insulation sheet, an antenna, and an IC chip. The IC chip includes in it a ferroelectric memory, nonvolatile memory, ROM, RAM, modem circuit, power supply circuit, encryption circuit, control circuit, etc. As the antenna member of this IC card, use is made of a covered copper wire coil, silver paste, aluminum foil, copper foil, or the like. These are selectively used according to the number of windings, application, production costs, etc. When the number of windings is small and a high conductivity is necessary, rolled pure copper foil or electrolytic copper foil is frequently used as the antenna material.

On the other hand, when using foil having large surface roughness such usual electrolytic copper foil as the material for the antenna, the impedance increases at the time of transmission and reception of the high frequency signal, so sometimes use is not possible in the high frequency region.

Further, the high strength and high conductivity copper alloy foil now being used as lead frame material etc. has a high material strength when compared with pure copper foil (hereinafter simply referred to as “copper foil” as opposed to “copper alloy foil”), but is insufficient for meeting recent demand such as faster speed of signal transmission, reduced size, and higher reliability.

Accordingly, in order to cope with the further reduction of pitch and lightening of weight, various applications for improving the characteristics of these conventional copper foil and copper alloy foil have been filed (refer to for example Japanese Unexamined Patent Publication (Kokai) No. 2002-167633), but none of these satisfy the characteristic of reduction of transmission loss in the high frequency region as for example an antenna material.

### DISCLOSURE OF THE INVENTION

In view of the above recent demands, the inventors engaged in intensive research in order to solve the above problems and as a result succeeded in developing a composite copper foil having a high conductivity and also having a low impedance by providing a layer having a small resistance like copper and/or silver on its surface and thereby providing a composite copper foil meeting recent demands. The inventors provide a composite copper foil excellent in conductivity and surface shape and, by employing a copper alloy rolled foil for applications where strength is particularly demanded, optimum even for applications of high frequency transmission circuits such as the antennas of IC cards, and a method of production of the same.

From the viewpoint of the conductivity of the copper or silver layer, the present invention was made based on the idea of, since the current flows through the surface layer in a high frequency region in applications of high frequency transmission circuits, arranging copper and/or silver excellent in conductivity at the surface, maintaining the strength by using copper foil or copper alloy rolled foil (material) as a core material, and, particularly in the case of applications where the usage environment requires repeated bending, employing copper alloy rolled foil excellent in repeated bending strength.

Further, in the present invention, due to arrangement at the surface, a high purity is preferable, but it is also possible to add slight amounts of additive elements for alloying.

A first aspect of the invention of the present application provides a composite copper foil characterized by having a copper foil (including a copper alloy foil) on at least one surface of which a copper and/or silver smoothing layer is provided.

As the copper foil, preferably a precipitated copper alloy rolled foil is employed.

A thickness of the smoothing layer of copper and/or silver is preferably at least 0.01 μm or more.

A surface roughness of the smoothing layer is preferably 0.3 to 5.0 μm in terms of Rz and 0.02 to 0.5 μm in terms of Ra.

Preferably, the smoothing layer is treated by either or both roughening treatment and/or rust-proofing treatment.

Especially, when strength is required in the usage environment, as the copper foil, preferably use is made of a copper alloy composite foil having a tensile strength of 500 N/mm² or more.

A second aspect of the invention of the present application provides a method of production of a composite copper foil characterized by processing an ingot having a copper alloy to a foil having a desired thickness by rolling, then forming on at least one surface of the processed copper alloy foil a smoothing layer by copper plating and/or silver plating.

A third aspect of the invention of the present application provides a method of production of a composite copper foil characterized by processing an ingot having a copper alloy to a foil having a thickness of an intermediate size by rolling, forming on at least one surface of the foil a smoothing layer by copper plating and/or silver plating, then rolling the result to a foil having a desired thickness.

A fourth aspect of the invention of the present application provides a method of production of a composite copper foil characterized by processing an ingot having a copper alloy to a foil having a thickness of an intermediate size by rolling, forming on at least one surface of the foil a smoothing layer by copper plating and/or silver plating, then applying heat treatment or applying heat treatment and rolling to thereby make the thickness of at least the copper and/or silver plating layer at the surface of the foil 0.01 μm or more.

Preferably, a step of treating the smoothing layer of the composite copper foil produced by the above method of production by roughening treatment and/or rust-proofing treatment of the copper is provided.

A fifth aspect of the invention of the present application provides a high frequency transmission circuit characterized by being prepared using the composite copper foil.

### BEST MODE FOR WORKING THE INVENTION

The layer of copper and/or silver constituting the smoothing layer formed on the surface of the composite copper foil in the present invention is formed on a core material given a desired thickness by plating. The layer of copper and/or silver may also be formed on a core material having an intermediate thickness (core material before rolling, annealing, or another process) to obtain an intermediate complex core material, then the intermediate complex core material processed to a foil by rolling, annealing, or another process. It is sufficient that in the end the surface of the foil be left with a thin smoothing layer.

Note that when processing a copper alloy rolled material to an intermediate thickness layer, plating the obtained core material with a layer of copper and/or silver, then heat treating or otherwise processing the result, if the core material given the intermediate thickness is a solid solution type or a precipitated/solid solution type alloy (for example containing zinc etc.), the heat treatment after plating the layer of copper and/or silver etc. causes the alloying element (Zn) to diffuse up to the surface layer (smoothing layer) for alloying up to the surface and therefore there is a risk of lowering the conductivity of the smoothing layer. Accordingly, it is necessary to appropriately set the heat treatment and other conditions and secure the conductivity of the surface layer.

Contrary to this, in the precipitated type, there is little diffusion of the alloying element to the surface due to the heating, therefore, the drop in the conductivity of the surface layer becomes small. This is more advantageous in comparison with the solid solution type.

When powering up a circuit prepared by conventional copper alloy foil with a high frequency, the resistance greatly increases due to the skin effect and induces an increase of the impedance, so normal transmission/reception of signals sometimes becomes impossible. The inventors analyzed this phenomenon and as a result found that if using the conventional copper alloy foil, since the copper alloy foil is lower in conductivity compared with pure copper foil, the influence of the skin effect is great.

Further, when pure copper foil and copper alloy foil both suffer from the above-mentioned trouble when the surface becomes rough. As indicators of surface roughness, both Rz and Ra are influential.

The inventors conducted various experiments and studies in the present invention and as a result found that the copper foil (including copper alloy foil) used as the core material preferably has an Rz of 5.0 μm or less and an Ra of 0.5 μm or less for the skin effect in high frequency transmission.

On the other hand, if the surface is too smooth, slippage occurs when conveying the composite copper foil and induces scratches in the foil surface. In the production and handling of foil (generally “foil” means foil with a thickness of 0.080 mm or less), unlike the production and handling of sheet, the foil must be conveyed on the line with a low tension due to its thin thickness, the conveyor rolls are harder to synchronize in comparison with sheet, and therefore slip scratching easily occurs. Slip scratching sometimes occurs over the entire length of the foil. When strong slip scratching occurs and exceeds 5.0 μm in Rz, the foil sometimes forms a fold at this position. Further, a product processed using a portion where large slip scratching occurs as a circuit part as it is becomes larger in impedance due to the skin effect in comparison with a product without slip scratching and cannot be used for a high frequency transmission circuit.

For this reason, the surface Rz of the composite copper foil is preferably made 0.3 μm or more, and the Ra is made 0.02 μm or more.

The foil must be high enough in strength to be able to withstand a tensile stress etc. acting on it when it is deformed in the process of assembling parts or when laying interconnects at a narrow pitch. Particularly, in a usage environment where repeated bending etc. is demanded, the composite copper foil must have a tensile strength of 500 N/mm² or more, desirably 700 N/mm² or more. If lower than this, breakage occurs at the time of assembly work and wrinkles and folding occur when rolling. This degrades the productivity. In addition, wrinkles are liable to increase the impedance.

In the present invention, by securing the strength of the foil by the core material (copper foil) and providing a metal having a high conductivity like copper or silver on the surface, the loss due to the skin effect at the time of high frequency transmission is reduced. The relationship between the frequency and the depth at which the current flows (skin depth) in a surface layer comprised of silver or copper is calculated as about 20 μm at 10 MHz, about 3 μm at 0.5 GHz, about 2 μm at 1 GHz, and about 0.6 μm at 10 GHz. Slight roughness of the surface or conductivity (containing impurities) has a large effect.

Regarding the thickness of the copper or silver layer present on the surface, due also to the added effect of smoothing the surface, a thickness of about 1/10 or more of the skin depth corresponding to the frequency for the application of use is enough to obtain the effect.

That is, in the touch type, proximity type, and midrange type, a thickness of about 2 μm is necessary, while in the microwave type, the effect is exhibited when the thickness is about 0.1 μm.

Note that, for forming a circuit by etching, a copper layer is preferable over silver since it is easily dissolved away by the same etchant.

Further, from the high frequency characteristics, the surface is preferably not formed with a roughened film or a rust-proofing film, but when adhesion with a resin etc. and corrosion resistance are required, the high frequency characteristics may be partially sacrificed to form the roughened film or the rust-proofing film.

For the roughened film, fine particles comprised of Cu or Cu and Co, Ni, Fe, or Cr or a mixture of these and oxides of elements such as V, Mo, or W are electrolytically precipitated. Note that it is preferred to further plate the roughened film with Cu to prevent flaking. Normally, a deposition amount of 0.01 mg/dm² or more can improve the adhesion force with the substrate resin.

Further, the surface may be further treated for rust-proofing and treated by a silane coupling agent. For the rust-proofing, generally the surface is further plated by Ni, Zn, or Cr, or an alloy of the same, is treated by chromate, or is treated for rust-proofing organically by BTA (benzotriazole) etc.

As the silane coupling agent, a vinyl-based one, epoxy-based one, etc. is suitably selected in accordance with the substrate used.

Next, the present invention will be explained in more detail by using examples.

Note that this explanation was made for the purpose of giving a general explanation of the present invention and has no limitative meaning at all.

### EXAMPLE 1

Electric copper was blended in as a main material and a copper beryllium matrix alloy and cobalt as sub materials. These were melted in vacuum in a high frequency melting furnace to produce a copper-beryllium-cobalt alloy. This was cast to an ingot having a thickness of 28 mm.

Next, the ingot was hot processed, repeatedly cold processed and solution heat treated, then finally cold rolled to obtain foil having a thickness of 33 μm. This was then aged. The composition of the obtained alloy was Be=0.4 wt %, and Co=5.2 wt %.

The surface of the obtained foil was treated by known pre-treatment, then a cyanide bath was used to plate Cu on both surfaces to a thickness of 1 μm. The surface roughness of the plated composite copper foil was 0.2 μm in terms of Ra and 3.1 μm in terms of Rz.

The tensile strength of the obtained composite copper foil was 1010 N/mm², and the conductivity was 30 IACS %.

### EXAMPLE 2

A copper alloy foil produced in the same way as Example 1 was plated in a cyanide bath with Ag instead of Cu on both surfaces to a thickness of 1 μm.

The roughness of the surface was 0.23 μm in terms of Ra and 3.2 μm in terms of Rz.

The tensile strength of the obtained copper alloy composite foil was 1020 N/mm², and the conductivity was 29 IACS %.

### EXAMPLE 3

Electric copper was blended in as a main material and a copper beryllium matrix alloy and cobalt as sub materials. These were melted in vacuum in a high frequency melting furnace in the same formulation as in Example 1 to produce a copper-beryllium-cobalt alloy. This was cast to an ingot having a thickness of 25 mm.

Next, the ingot was hot worked, repeatedly cold worked and solution heat treated, then finally cold rolled to obtain foil having a thickness of 29 μm, then the two surfaces were plated with Cu in a copper cyanide bath to a thickness of 3 μm, then aged.

The surface roughness was 0.2 μm in terms of Ra and 2.2 μm in terms of Rz.

The tensile strength of the obtained composite copper foil was 920 N/mm², and the conductivity was 36 IACS %.

### EXAMPLE 4

The ingot cast in Example 3 was hot worked, repeatedly cold worked and solution heat treated to obtain a core material having an intermediate thickness of 35 μm, then was plated at both surfaces by copper cyanide to a thickness 3 μm, then finally cold rolled to obtain a composite copper foil having a thickness of 35 μm. This was then aged.

The roughness of the surface was 0.17 μm in terms of Ra and 2.1 μm in terms of Rz.

The tensile strength of the obtained composite foil was 910 N/mm², and the conductivity was 35 IACS %.

### COMPARATIVE EXAMPLE 1

Electric copper was blended in as a main material and a copper beryllium matrix alloy and cobalt as sub materials. These were melted in vacuum in a high frequency melting furnace to produce a copper-beryllium-cobalt alloy. This was cast to an ingot of the same metal composition as Example 1 and having a thickness of 30 mm.

Next, the ingot was hot worked, repeatedly cold worked and solution heat treated, then finally cold rolled to obtain foil having a thickness of 35 μm. This was then aged.

The roughness of the surface was 0.3 μm in terms of Ra and 3.6 μm in terms of Rz.

The tensile strength was 1080 N/mm², and the conductivity was 26 IACS %.

(Measurement of Transmission Loss (1))

The composite copper foils obtained in Examples 1 to 4 and the copper alloy foil obtained in Comparative Example 1 were measured for transmission loss.

In the evaluation, each of the copper foils prepared in Examples and Comparative Example 1 was placed on a glass fabric prepreg impregnated with a high frequency substrate use resin and heat pressed to obtain a laminate, then the foil surface was covered with a dry film etching resist and etched to prepare a high frequency printed circuit board. Patterns were obtained with a width of the foil of the circuit board of 100 μm and a distance between conductors of 100 μm. This was used to transmit a signal of 4 GHz over 500 mm, and the transmission loss was measured.

The rates of reduction of the transmission loss by the examples compared with Comparative Example 1 were as follows:

Example 1: 13%

Example 2: 12%

Example 3: 42%

Example 4: 35%

Further, none of the examples suffered from slip scratching etc. in production, and the appearances were good.

### EXAMPLE 5

8% tin-phosphorus bronze, electric copper, phosphorus-containing copper, and tin were used as starting materials and cast in vacuum to obtain an ingot having a thickness of 30 mm. The composition was Sn=8.2 wt % and P=0.03 wt %.

The ingot was hot worked, then repeatedly cold worked and rolled to obtain a foil having a thickness of 30 μm. The obtained foil was treated by known pretreatment, then a glossy copper sulfate plating bath was used to plate the two surfaces with copper to a thickness of 2.5 μm.

The surface roughness was 0.2 μm in terms of Ra and 1.8 μm in terms of Rz.

The tensile strength of the obtained composite foil was 610 N/mm², and the conductivity was 25 IACS %.

### EXAMPLE 6

A copper alloy composite foil prepared in the same way as Example 5 was, to simulate low temperature annealing, heated in the atmosphere at 250° C. for 30 minutes, then the surface was pickled by sulfuric acid.

The roughness and the tensile strength were equivalent to those of Example 5, and the conductivity was 23 IACS %.

### EXAMPLE 7

The copper alloy composite foil of Example 5 was burnt plated, then encapsulated and finely roughening treated. Further, as rust-proofing treatment, the foil was electroplating with Cr to 0.02 mg/dm² and was treated by a vinyl-based silane coupling agent.

The roughness was 0.27 μm in terms of Ra and 2.5 μm in terms of Rz, and the tensile strength and conductivity were equivalent to those of Example 5.

### EXAMPLE 8

The same procedure was followed as in Example 5 to obtain a foil having a thickness of 34.6 μm. This foil was treated by known pretreatment, then the two surfaces were plated in a cyanide bath with Ag to a thickness of 0.1 μm, then were plated with glossy copper sulfate to a thickness of 0.1 μm.

The roughness was 0.3 μm in terms of Ra, and 3.0 μm in terms of Rz. The tensile strength was 692 N/mm², and the conductivity was 13 IACS %.

### COMPARATIVE EXAMPLE 2

The ingot having the thickness of 30 mm obtained in Example 5 was hot worked, then repeatedly cold worked and rolled to obtain a foil having a thickness of 35 μm.

The surface roughness was 0.4 μm in terms of Ra, and 3.2 μm in terms of Rz. The tensile strength was 700 N/mm², and the conductivity was 12 IACS %.

(Measurement of Transmission Loss (2))

These foils were measured for transmission loss by the same method as that described above.

The rates of reduction of the transmission loss when comparing Examples 5 to 8 and Comparative Example 2 were as follows.

Example 5: 35%

Example 6: 23%

Example 7: 13%

Example 8: 9%

In the above as well, the examples were free from slip scratching in production, and the appearances were good.

(Measurement of Strength)

Further, compared with the about 400 N/mm² strength of the conventional electrolytic copper foil and pure copper foil obtained by rolling, the composite copper foil of the present invention has a high strength of about 1000 N/mm² in Examples 1 to 4 and 600 N/mm² or more also in Examples 5 and 8. Further, the repeated bending strength is also about three times as a result of the measurement.

As mentioned above, the composite copper foil of the present invention has little high frequency transmission loss in comparison with the conventional electrolytic copper foil and rolling and is excellent particularly for copper foil for high frequency circuit use.

Further, the present invention is not limited to any special copper alloy and can be applied to both electrolytic copper foil and rolled copper foil (including alloy foil) having problems particularly for high frequency transmission circuits due to the surface roughness, so the present invention has a high industrial value.

Further, particularly, when using precipitated copper alloy etc., it can be preferably used for applications where a high strength is required. Its industrial value is therefore high.

Further, the composite copper foil of the present invention is provided with excellent characteristics as a high frequency transmission circuit, therefore exhibits excellent effects which can be suitably used for an antenna material of contact type and non-contact type IC cards.

Other than them, various modifications are possible within a range not out of the gist of the present invention.

### INDUSTRIAL APPLICABILITY

The composite copper foil of the present invention can be applied to copper foil for a high frequency transmission circuit such as the antenna of an IC card.

The method of production of the composite copper foil of the present invention can be applied for producing copper foil for a high frequency transmission circuit such as the antenna of an IC card.

The high frequency transmission circuit of the present invention can be applied to the antenna etc. of an IC card.

1. A composite copper foil characterized by comprising a copper foil on at least one surface of which a copper and/or silver smoothing layer is provided.

2. A composite copper foil as set forth in claim 1, characterized in that a thickness of said smoothing layer is 0.01 μm or more.

3. A composite copper foil as set forth in claim 1, characterized in that a surface roughness of said smoothing layer is 0.3 to 5.0 μm in terms of Rz and 0.02 to 0.5 μm in terms of Ra.

4. A composite copper foil as set forth in claim 2, characterized in that a surface roughness of said smoothing layer is 0.3 to 5.0 μm in terms of Rz and 0.02 to 0.5 μm in terms of Ra.

5. A composite copper foil as set forth in claim 1, characterized in that said copper foil is a copper alloy rolled foil.

6. A composite copper foil as set forth in claim 5, characterized in that said copper alloy rolled foil is a precipitated alloy.

7. A composite copper foil as set forth in claim 5, characterized in that a surface roughness of said smoothing layer is 0.3 to 5.0 μm in terms of Rz and 0.02 to 0.5 μm in terms of Ra.

8. A composite copper foil as set forth in claim 6, characterized in that a surface roughness of said smoothing layer is 0.3 to 5.0 μm in terms of Rz and 0.02 to 0.5 μm in terms of Ra.

9. A composite copper foil as set forth in any one of claims 1 to 4, characterized in that said smoothing layer is treated by roughening treatment and/or rust-proofing treatment.

10. A composite copper foil as set forth in any one of claims 5 to 8, characterized in that said smoothing layer is treated by roughening treatment and/or rust-proofing treatment.

11. A composite copper foil as set forth in any one of claims 5 to 8, characterized in that a tensile strength of said composite copper foil including said copper alloy rolled foil is 500 N/mm² or more.

12. A composite copper foil as set forth in any one of claim 10, characterized in that a tensile strength of said composite copper foil including said copper alloy rolled foil is 500 N/mm² or more.

13. A method of production of a composite copper foil characterized by processing an ingot comprising a copper alloy to a foil having a desired thickness by rolling, then forming on at least one surface of the processed copper alloy foil a smoothing layer by copper plating and/or silver plating.

14. A method of production of a composite copper foil characterized by processing an ingot comprising a copper alloy to a foil having a thickness of an intermediate size by rolling, forming on at least one surface of the foil a smoothing layer by copper plating and/or silver plating, then rolling the result to a foil having a desired thickness.

15. A method of production of a composite copper foil characterized by processing an ingot comprising a copper alloy to a foil having a thickness of an intermediate size by rolling, forming on at least one surface of the foil a smoothing layer by copper plating and/or silver plating, then applying heat treatment or applying heat treatment and rolling to thereby make the thickness of at least the copper and/or silver plating layer at the surface of the foil 0.01 μm or more.

16. A method of production of a composite copper foil as set forth in any one of claims 13 to 15, characterized by further treating said smoothing layer by roughening treatment and/or rust-proofing treatment of the copper.

17. A high frequency transmission circuit characterized by being prepared using the composite copper foil as set forth in any one of claims 1 to 8.

18. A high frequency transmission circuit characterized by being prepared using the composite copper foil as set forth in claim 9.

19. A high frequency transmission circuit characterized by being prepared using the composite copper foil as set forth in claim 10.

20. A high frequency transmission circuit characterized by being prepared using the composite copper foil as set forth in claim 11.

21. A high frequency transmission circuit characterized by being prepared using the composite copper foil as set forth in claim 12.

22. A high frequency transmission circuit characterized by being prepared using the composite copper foil produced by a method of production as set forth in any one of claims 13 to 15.

23. A high frequency transmission circuit characterized by being prepared using the composite copper foil produced by a method of production as set forth in claim 16.
